(19) United States
(12) Patent Application Publication
(10) Pub. No.: US 2007/0221312 A1
(43) Pub. Date: Sep. 27, 2007

(54) Manufacturing method of plugged honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/714,731

(22) Filed: Mar. 7, 2007

(30) Foreign Application Priority Data
Mar. 22, 2006 (JP) 2006-078566
Jan. 25, 2007 (JP) 2007-015514

(51) Int. Cl. C03B 29/00

(52) U.S. Cl. 156/89.11

(57) ABSTRACT

This method is a manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure. Openings of all cells of a honeycomb structure are filled with a slurry-like plugging material. Separately, an image of end-surface cells of the honeycomb structure is picked up with a camera. A photo-setting or thermosetting resin film is attached to an end surface of the honeycomb structure in which all of the cells are plugged. After a plugging pattern is printed on the film, the honeycomb structure to which a printed film is attached is irradiated with light or heat by use of a light or heat source. In consequence, only target film portions are allowed to set. At cell portions which have not set, film portions which have not set are removed together with a plugging material with pressurizing air or sandblast.

### BACKGROUND OF THE INVENTION

1. Field of the Invention

The present invention relates to a manufacturing method of a plugged honeycomb structure. The present invention particularly relates to a manufacturing method of a plugged honeycomb structure, capable of easily and inexpensively manufacturing the plugged honeycomb structure so that deposits deposited on an end surface of the structure are reduced during use as a filter or the like. The present invention more particularly relates to a manufacturing method of a plugged honeycomb structure, capable of easily making a plugging depth of the honeycomb structure uniform.

2. Description of the Related Art

In recent years, in various fields including chemistry, power, iron and steel and industrial waste disposal, a plugged honeycomb structure made of a ceramic having excellent resistances to heat and corrosion has been used as a dust collecting filter in applications of environmental measures such as pollution preventive measures, recovery of a product from a high-temperature gas and the like. For example, such a plugged honeycomb structure is preferably used as a dust collecting filter such as a diesel particulate filter (DPF) which traps particulates discharged from a diesel engine in an atmosphere of a corrosive gas at a high temperature (e.g., Patent Document 1).

As shown in FIG. 7, the plugged honeycomb structure for use as the above dust collecting filter includes a cylindrical honeycomb structure 23 having porous partition walls 22 which form a plurality of cells 24 divided as channels of a fluid; and plugging members 26 which plug one opening of each of predetermined cells and the other opening of each of remaining cells. In a plugged honeycomb structure 21 shown in FIG. 7, the plugging members 26 alternately plug an inlet-side end surface B and an outlet-side end surface C of the plurality of cells 24.

The plugged honeycomb structure 21 can be manufactured by extruding a material to obtain a non-fired cylindrical honeycomb structure having the porous partition walls which form the plurality of cells divided as the channels of the fluid; then filling, with a plugging slurry including the ceramic, one opening of each of the predetermined cells and the other opening of each of the remaining cells of the resulting non-fired honeycomb structure or a honeycomb structure obtained by firing the non-fired honeycomb structure; and then firing the structure.

Furthermore, a conventional manufacturing method of the plugged honeycomb structure for use as the above dust collecting filter is shown in FIGS. 6(a) and 6(b). As shown in FIG. 6(a), for example, a film 2 is attached to one end of a formed honeycomb body 1 which is a non-fired ceramic dry body. Pores are made at only portions 3 corresponding to cells (plugged cells) of the film 2 to be plugged by laser processing or the like using image processing to obtain a mask 4. Next, as shown in FIG. 6(b), the end surface of the formed honeycomb body 1 to which the mask 4 is attached is immersed into a slurry (a ceramic slurry) 5. The cells of the formed honeycomb body 1 to be plugged are filled with the slurry 5 to form plugging portions. The other end surface of the formed honeycomb body 1 is also subjected to steps similar to the above steps. Subsequently, the body is dried and fired to thereby obtain the plugged honeycomb structure. This method has been proposed (e.g., Patent Document 2).

[Patent Document 1] Japanese Patent Application Laid-Open No. 2001-300922; and

[Patent Document 2] Japanese Patent Application Laid-Open No. 2005-270755.

In the above manufacturing method of the plugged honeycomb structure, the pores are made in the film by laser. In this method, since the pores tend to be smaller than the cell openings, a plugging material does not easily enter the cells during the filling of the cells with the plugging material in some case. A diameter of the pore to be made at an incomplete cell at an outer peripheral portion of the honeycomb structure needs to be reduced. Therefore, laser irradiation conditions need to be changed. There has been a problem that perforating becomes complicated.

The present inventor has aimed at providing a manufacturing method in which the pores having the same shape as that of each cell opening are made to thereby solve a problem that the plugging material cannot easily enter the cells during the filling of the cells with the plugging material and a problem that the perforating be facilitated, and has reached the present invention.

### SUMMARY OF THE INVENTION

To solve the above problem, an object of the present invention is to provide a manufacturing method of the following plugged honeycomb structure.

[1] A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure, the method comprising: picking up an image of an end surface of the honeycomb structure beforehand; then synthesizing a predetermined plugging pattern at an end-surface cell group of the honeycomb structure end surface by processing of the picked-up image; printing the resulting synthetic image on a photo-setting or thermosetting resin film formed on the honeycomb structure end surface; then irradiating the honeycomb structure end surface with light or heat; leaving a portion which has set while removing the film to form an opening having the predetermined plugging pattern at the photo-setting or thermosetting resin film; and filling the cells of the honeycomb structure with a plugging material to form the plugging portions.

[2] The manufacturing method of the plugged honeycomb structure according to the above [1], wherein the synthesized plugging pattern is printed beforehand on the photo-setting or thermosetting resin film; and the film is attached to the end surface of the honeycomb structure.

[3] A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure, the method comprising: filling all of the cells of a honeycomb structure end surface with a plugging material beforehand; then forming a photo-setting or thermosetting resin film on the end surface; picking up an image of the end surface of the honeycomb structure beforehand; then synthesizing a predetermined plugging pattern at an end-surface cell group of the honeycomb structure end surface by processing of the picked-up image; printing the resulting synthetic image on the photo-setting or thermosetting resin film formed on the honeycomb structure end surface; then irradiating the honeycomb structure end surface with light or heat so that the photo-setting or thermosetting resin film of the predetermined cell sets; removing the photo-setting or thermosetting resin film which has not set together with the plugging material; then removing the photo-setting or thermosetting resin film which has set to form the plugging portions.

[4] A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure, the method comprising: filling all of the cells of the honeycomb structure with a plugging material containing a photo-setting or thermosetting resin beforehand; irradiating an end surface with laser in the form of a plugging pattern based on information of a honeycomb structure end surface image picked up beforehand so that the plugging material of the predetermined cell sets; and removing the plugging material which has not set to thereby form the plugging portions.

[5] A manufacturing method of a plugged honeycomb structure including porous partition walls which form a plurality of cells divided as channels of a fluid in the form of a honeycomb and plugging portions formed at one opening end portion of a predetermined cell of a cylindrical honeycomb structure, the method comprising: filling all of the cells of a honeycomb structure end surface with a plugging material beforehand; then forming a photo-setting or thermosetting resin film on the end surface of the honeycomb structure; then irradiating the end surface with laser in the form of a plugging pattern based on information of a honeycomb structure end surface image picked up beforehand so that the photo-setting or thermosetting resin film of the predetermined cell sets; removing the photo-setting or thermosetting resin film which has not set together with the plugging material; and then removing the photo-setting or thermosetting resin film which has set to thereby form the plugging portions.

According to the manufacturing method of the present invention, the following effect is produced. That is, pores are made in the film along the plugging pattern printed on the film based on a cell shape of the photographed end surface. Therefore, the pores can substantially be the same as the cell openings. Therefore, the plugging material easily enters the cells. This solves a problem that the plugging material does not easily enter the cells during the filling of the cells with the plugging material. Even in an incomplete cell of an outermost periphery of the honeycomb structure, substantially the same pores as the cell openings can similarly be processed. Therefore, a problem to facilitate perforating is also solved. Furthermore, according to another configuration of the present invention, after filling all of the cells of the honeycomb structure end surface with the plugging material beforehand, the photo-setting or thermosetting resin film is formed on the end surface. Alternatively, the resin sets at an only cell portion to be plugged by filling the cells with the plugging material containing the photo-setting or thermosetting resin. This configuration solves the problem that the plugging material does not easily enter the cells during the filling of the cells with the plugging material. In addition, the resin which has not set can easily be removed, and the problem to facilitate the perforating can therefore be solved.

### BRIEF DESCRIPTION OF THE DRAWINGS

FIGS. 1(a) to 1(e) are step diagrams showing a printing step on a film formed on a honeycomb structure end surface according to one embodiment of the present invention;

FIGS. 2(a) to 2(d) are step diagrams subsequent to FIGS. 1(a) to 1(e), showing a setting step by irradiation of a honeycomb structure with light or heat and a step of fixing a plugging material;

FIGS. 3(a) to 3(g) are step diagrams showing another embodiment of the present invention;

FIGS. 4(a) to 4(d) are step diagrams showing still another embodiment of the present invention;

FIGS. 5(a) to 5(e) are step diagrams showing a further embodiment of the present invention;

FIGS. 6(a) and 6(b) are step diagrams showing a conventional manufacturing method of a plugged honeycomb structure; and

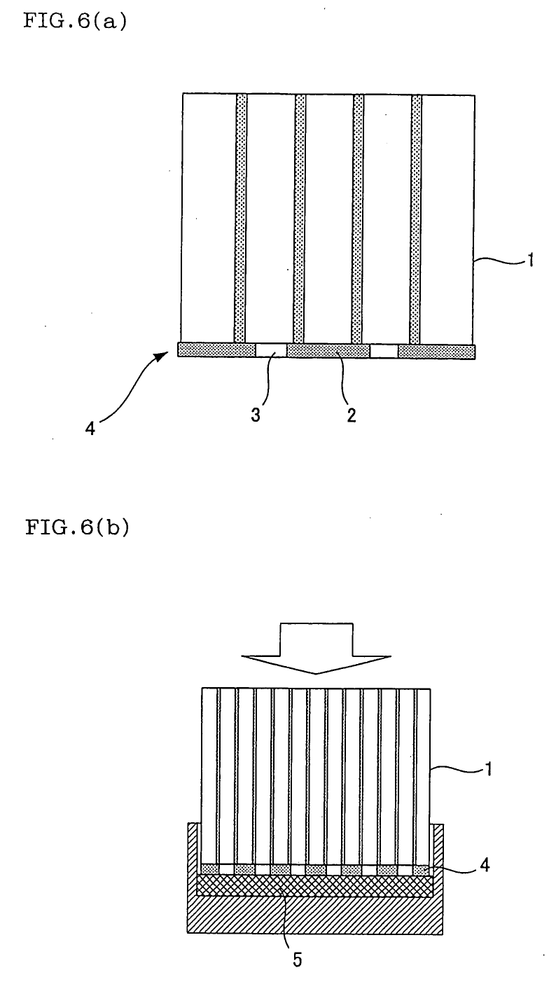

FIG. 7 is a sectional view showing a constitution of the plugged honeycomb structure.

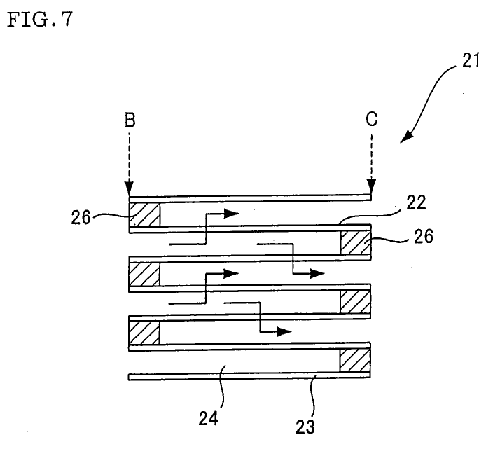

### DESCRIPTION OF THE PREFERRED EMBODIMENT

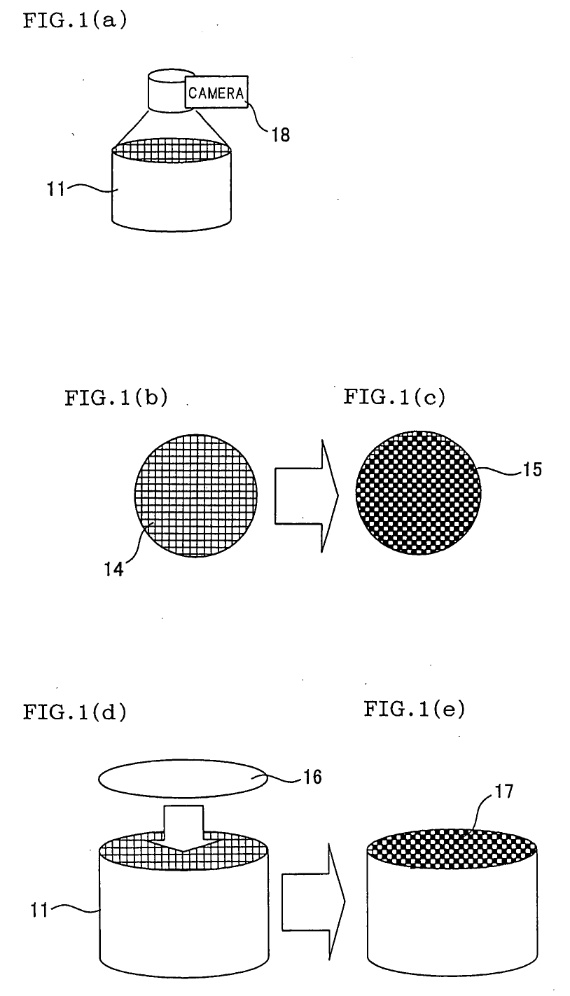

Embodiments of a manufacturing method of a plugged honeycomb structure according to the present invention will hereinafter be described with reference to specific configurations of the present invention shown in FIGS. 1 to 5. However, the present invention is not restricted by this description when interpreted, and can variously be altered, modified and improved based on knowledge of any person skilled in the art without departing from the scope of the present invention.

A plugging material obtained by adding a binder, a dispersion medium and the like to ceramic powder such as cordierite powder to knead the material is preferably usable as a plugging member for use in the present invention. For example, the plugging member can be prepared by adding water, a binder and glycerin to the cordierite powder.

Moreover, as a material of the honeycomb structure of the present invention, from viewpoints of strength, a heat resistance and the like, it is preferable that one material is selected as a main crystal phase from the group consisting of cordierite, silicon carbide, alumina, mullite, aluminum titanate and lithium aluminum silicate (LAS). It is to be noted that, when the same slurry as that of the honeycomb structure is used as a slurry of the plugging material, there is an effect that coefficients of thermal expansion of both of the slurries meet with each other.

A cylindrical honeycomb structure including porous partition walls which form a plurality of cells divided as channels of a fluid in the form of a honeycomb is manufactured by a method described in, for example, Patent Document 2. For example, a ceramic-containing forming material can be extruded to obtain a cylindrical non-fired honeycomb structure having the porous partition walls which form the plurality of cells divided as the channels of the fluid. As the ceramic-containing forming material, a material is preferably usable which is obtained by adding the binder, the dispersion medium and the like to the powder of a ceramic such as cordierite, mullite, alumina, spinel, silicon carbide, silicon nitride, lithium aluminum silicate or aluminum titanate and kneading the material. There is not any special restriction on an extruding method, but a heretofore known method such as extrusion using a vacuum extruder may be used.

FIGS. 1(a) to 1(e) are explanatory views of a printing step on a film formed on a honeycomb structure end surface in the present invention. In this embodiment, as shown in FIG. 1(a), first a cell image of an end surface of a honeycomb structure 11 is photographed by a camera 18 to obtain a cell image 14 as shown in FIG. 1(b). Subsequently, a predetermined plugging pattern is synthesized from the resulting cell image 14 by image processing to obtain a synthetic image 15 as shown in FIG. 1(c). On the other hand, as shown in FIG. 1(d), a photo-setting or thermosetting resin film 16 is attached to the end surface of the honeycomb structure 11 beforehand, and the synthetic image 15 obtained as described above is printed on this photo-setting or thermosetting resin film 16 as shown in FIG. 1(e) to obtain a printed film 17.

In the present invention, a photo-setting resin is a resin which sets with ultraviolet light or visible light. For example, a portion of the resin irradiated with pulse laser light, He—Cd laser light or argon laser light is polymerized to set, and an epoxy-based resin is preferable because it has versatility.

Moreover, a thermosetting resin is a liquid or powder low-molecular or thermoplastically macromolecular resin having a property of changing to an insoluble macromolecular resin having a three-dimensional mesh structure at a time when a crosslinking reaction occurs between molecules during heating or the like. Examples of the resin include an urea resin, a melamine resin, a phenol resin, an epoxy resin, an unsaturated polyester resin, an acrylic resin and the like. These resins have chemically reactive functional groups in molecules.

To print the plugging pattern, the pattern may be printed in light absorbing ink, heat absorbing ink or the like on the photo-setting or thermosetting resin film, or the photo-setting or thermosetting resin may be printed on a support film. As the support film on which the photo-setting or thermosetting resin is printed, a polyethylene film, a polypropylene film or a polyester film may be used. The film may be subjected to a surface treatment beforehand and then used. Especially, for ink jet printing, it is preferable to treat the surface of the film with, for example, polyacryl powder, unsaturated polyester powder or the like. During the surface treatment, a corona discharge treatment may be performed.

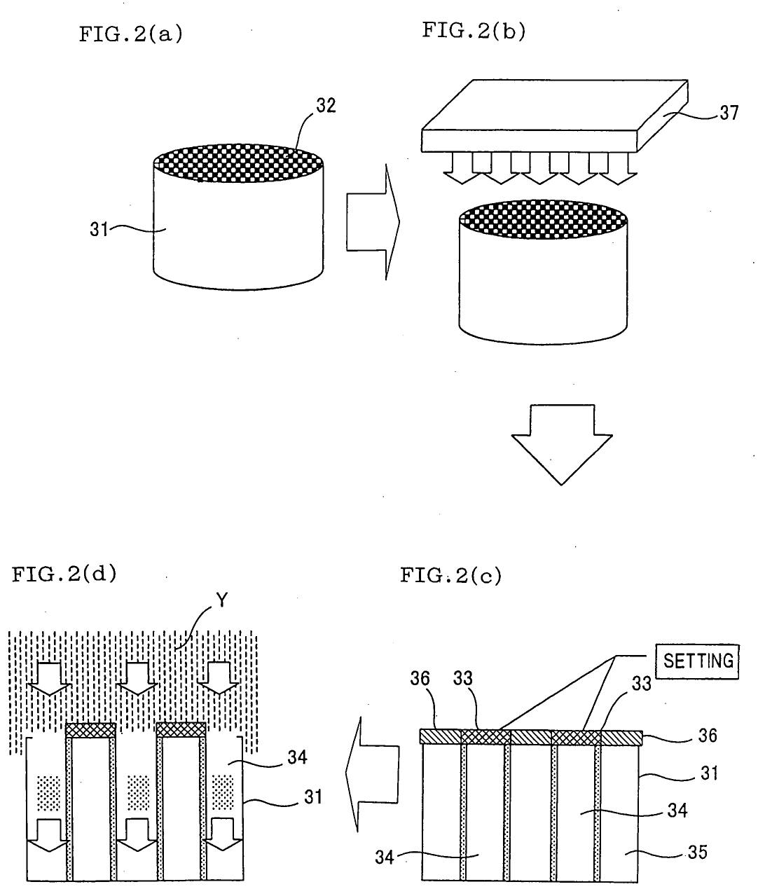

Next, steps will be described with reference to FIGS. 2(a) to 2(d). The honeycomb structure obtained as shown in FIGS. 1(a) to 1(e) and having the printed film on the end surface thereof is irradiated with light or heat so that the film sets, and the plugging material is fixed. A honeycomb structure 31 to which a printed film 32 is attached is irradiated with the light or the heat by use of a source 37, for example, a source of light such as an ultraviolet ray or a heat source such as a halogen lamp as shown in FIG. 2(b). In consequence, only target portions 33 of the film set as shown in FIG. 2(c). The films 33 of cell portions 34 which have set are fixed to the end surface of the honeycomb structure 31. On the other hand, at cell portions 35 which have not set, as shown in FIGS. 2(c) and 2(d), films 36 of the portions which do not set are removed with pressurizing air or sandblast Y. It is to be noted that in the next step, the film 33 which has set may be removed after filling the cells with the plugging members by a heretofore known method, or may be burnt out by firing the honeycomb structure. In consequence, the plugged honeycomb structure having the end surface plugged in a desired pattern is manufactured.

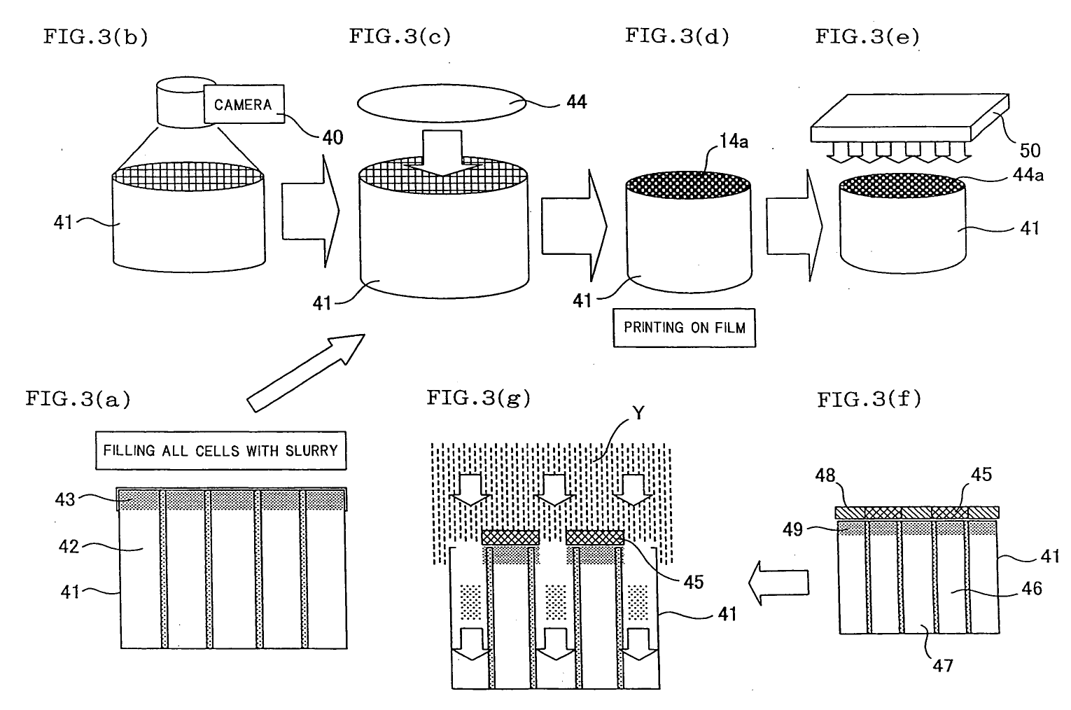

Next, another embodiment of the present invention will be described with reference to FIGS. 3(a) to 3(g). As shown in FIG. 3(a), first, all of cells 42 of a honeycomb structure 41 are filled with a slurry-like plugging material 43. Separately, as shown in FIG. 3(b), an image of end-surface cells of the honeycomb structure 41 is picked up with a camera 40. Subsequently, as shown in FIG. 3(c), a photo-setting or thermosetting resin film 44 is attached to an end surface of the honeycomb structure 41 in which all of the cells are plugged. Subsequently, in the same manner as in FIGS. 2(a) to 2(d), after a plugging pattern is printed on the film 44 as shown in FIG. 3(d), the honeycomb structure 41 to which a printed film 44a is attached is irradiated with light or heat by use of a light or heat source 50 as shown in FIG. 3(e). In consequence, as shown in FIG. 3(f), only target film portions 45 are allowed to set. The film portions 45 of cell portions 46 which have set are fixed to the end surface of the honeycomb structure 41. On the other hand, at cell portions 47 which have not set, as shown in FIG. 3(g), film portions 48 which have not set are removed together with a plugging material 49 with pressurizing air or sandblast Y. It is to be noted that the remaining film portions 45 which have set on the end surface may be removed with normal means or may be burnt out by firing.

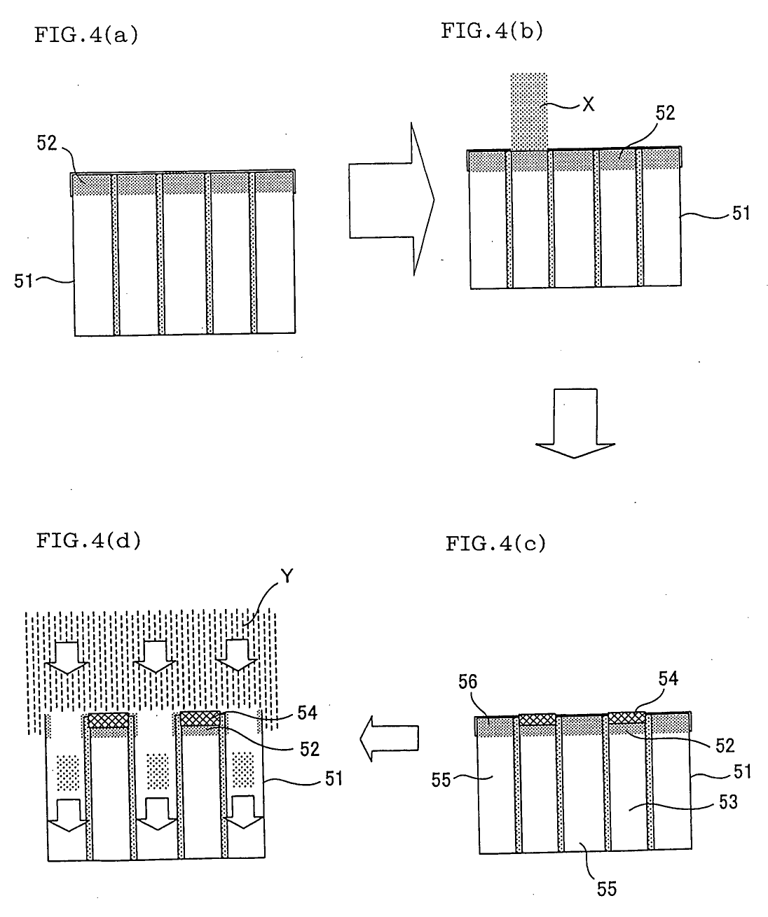

A still another embodiment of the present invention will be described with reference to FIGS. 4(a) to 4(d). As shown in FIG. 4(a), openings of all cells of a honeycomb structure 51 are filled with a plugging material 52 containing a photo-setting or thermosetting resin beforehand. Subsequently, as shown in FIG. 4(b), an end surface of the honeycomb structure 51 provided with the plugging material 52 is irradiated with laser X in the form of a plugging pattern (e.g., a zigzag pattern) based on information of an end-surface image of the honeycomb structure 51 picked up beforehand. In consequence, as shown in FIG. 4(c), surface portions 54 of the plugging material 52 of predetermined cells 53 are allowed to set, and the surface portions 54 which have set are fixed to the end surface of the honeycomb structure 51. On the other hand, as shown in FIGS. 4(c) and 4(d), a plugging material 56 of cell portions 55 which have not set are removed by the sandblast Y or the like.

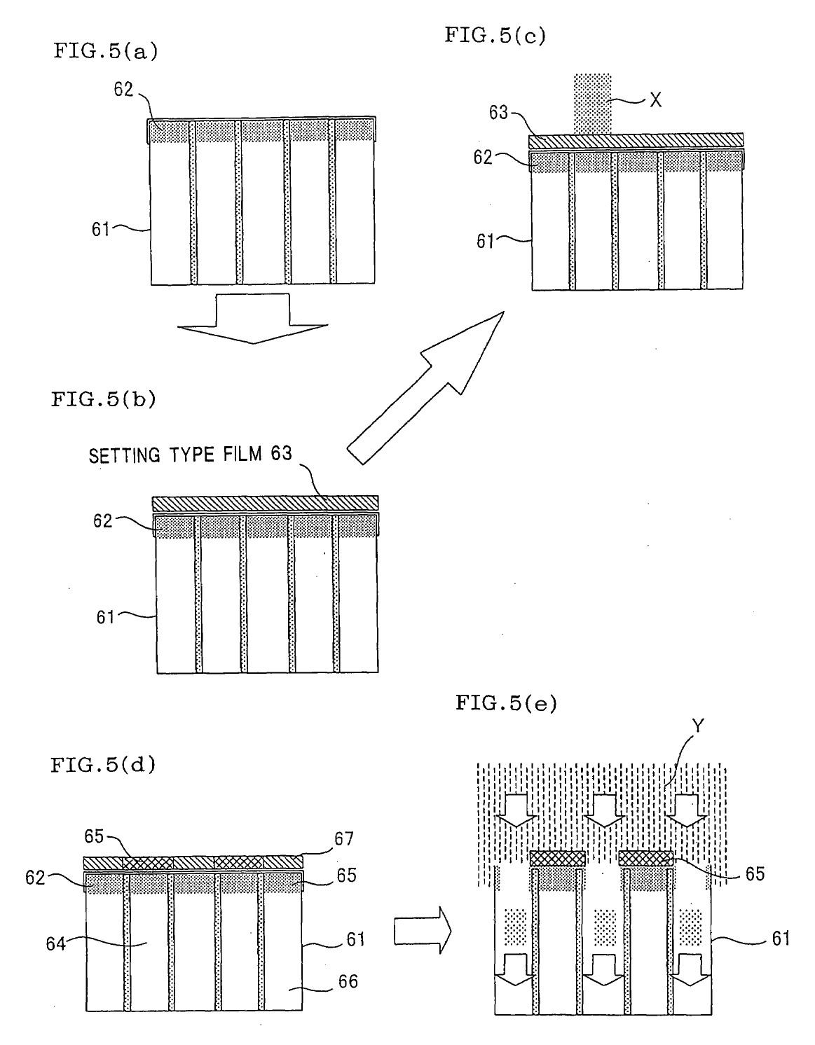

A further embodiment of the present invention will be described with reference to FIGS. 5(a) to 5(e). As shown in FIG. 5(a), openings of all cells at an end surface of a honeycomb structure 61 are filled with a plugging material 62 beforehand. Subsequently, as shown in FIG. 5(b), a photo-setting or thermosetting resin film 63 is formed on the end surface provided with the plugging material 62. Subsequently, as shown in FIG. 5(c), the end surface provided with the photo-setting or thermosetting resin film 63 of the honeycomb structure 61 is irradiated with laser X in the form of a plugging pattern (e.g., a zigzag pattern) based on information of an end-surface image of the honeycomb structure 61 picked up beforehand. In consequence, as shown in FIG. 5(d), films 65 of predetermined cells 64 are allowed to set, and the films 65 which have set are fixed to the end surface of the honeycomb structure 61. On the other hand, as shown in FIGS. 5(d), 5(e), films 67 of cell portions 66 which have not set are removed together with a plugging material 68 by sandblast Y or the like.

It is to be noted that the photo-setting or thermosetting resin film 63 may be formed by attaching the film to the end surface or coating the end surface with the photo-setting or thermosetting resin. The film 65 which has set may be removed by usual means or may be burnt out by firing.

It is to be noted that according to the manufacturing method of the plugged honeycomb structure of the present embodiment, a catalyst may be carried by inner surfaces and/or inner portions of the partition walls of the plugged honeycomb structure obtained by the above method. When the plugged honeycomb structure is used as, for example, a DPF, it is preferable to carry a catalyst having a function of promoting burning of deposits (particulate substances) captured by the partition walls. Preferable examples of such a catalyst include noble metals such as Pt, Pd and Rh and a non-metal based catalyst of a perovskite type. A method of carrying the catalyst can be performed in conformity to a conventional method of carrying-the catalyst by a filter such as the DPF.

### EXAMPLES

The present invention will hereinafter be described more specifically in accordance with examples.

### Example 1

A raw material such as a cordierite forming material containing talc, kaolin and alumina as main materials is mixed with water, a binder, a surfactant and the like, dispersed, mixed and kneaded to obtain a forming material. The material is formed into a columnar shape with a clay kneader, and extruded with an extruder to obtain a cylindrically formed cell (honeycomb) body having partition walls which form a plurality of cells divided as channels of a fluid and an outer wall formed integrally with the partition walls. To manufacture a honeycomb structure by use of the formed body obtained in this manner, the resultant formed body is dried and then cut into predetermined lengths to obtain dried bodies. After alternately plugging cell groups of opposite end surfaces of each dried body, the body is fired to obtain a fired body. To fill openings of the cells with a plugging material, when the plugging material is vibrated, the filling is facilitated. This is preferable because a uniform plugging depth is obtained. Next, after grinding and removing an outer peripheral wall and partition walls of about one to three cells present from an outermost periphery of the resultant fired body, an outer periphery is coated with a ceramic coating material to form an outer peripheral wall. In consequence, the honeycomb structure made of cordierite can be obtained.

Specifically, it was possible to manufacture a honeycomb structure having a quadrangular cell sectional shape, a partition wall thickness of 0.3 mm, a reference cell density of 300 cpsi (46.5 cells/cm²), a columnar (an outer diameter: 191 mm, a length: 203 mm) outer shape of the honeycomb structure having the coated outer periphery and a plugging depth of 10 mm. Similarly, it was possible to obtain a honeycomb structure having a quadrangular cell sectional shape, a partition wall thickness of 0.3 mm, a reference cell density of 200 cpsi (31 cells/cm²), and a columnar (an outer diameter: 330 mm, a length: 305 mm) outer shape after the outer periphery of the honeycomb structure was coated. It was also possible to obtain a honeycomb structure having a columnar (an outer diameter: 460 mm, a length: 500 mm) outer shape after the outer periphery of the honeycomb structure was coated.

These cell structures have characteristics that a porosity is in a range of 40 to 80%, a mean pore diameter is in a range of 5 to 50 μm and an average coefficient of thermal expansion in an axial direction at 40 to 800° C. is in a range of about 0.1 to 2.0×10⁻⁶/° C.

Moreover, a honeycomb structure having an outer diameter of 191 mm to 460 mm was manufactured using the same raw material so that cells had a sectional shape formed by combining octagonal and quadrangular shapes, a partition wall thickness was 0.41 mm and a reference cell density was 300 cpsi (46.5 cells/cm²). Furthermore, a cell structure was manufactured so that an integrally formed outer shape including a non-processed outer periphery had a columnar shape (an outer diameter: 144 mm, a length: 152 mm), cells had a sectional shape formed by combining octagonal and quadrangular shapes, a partition wall thickness was 0.41 mm a reference cell density was 300 cpsi (46.5 cells/cm²), and a plugging depth was 3 mm. A cell structure having an equal dimension and an equal plugging depth was also manufactured so that the cells had a quadrangular sectional shape, a partition wall thickness was 0.43 mm and a reference cell density was 100 cpsi (15.5 cells/cm²) .

In the honeycomb structure of a coated outer periphery type formed by processing and removing an outer peripheral portion of a plugged body and coating an outer periphery with a ceramic to form an outer wall, partial cells positioned at an outermost peripheral portion of the honeycomb structure do not have to be necessarily plugged. However, in the honeycomb structure of an integrally formed outer wall type, it is preferable for a filter performance that the partial cells to be plugged, positioned at an outermost periphery, are plugged and the other cells are not plugged. According to the present method, the partial cells are also faithfully photographed to form a plugging pattern. Therefore, in the honeycomb structure of the integrally formed outer wall type, the partial cells to be plugged, positioned at the outermost periphery, can be plugged while the other cells are not plugged.

In various fields including chemistry, power, iron and steel and industrial waste disposal, a plugged honeycomb structure obtained by a manufacturing method according to the present invention is used as a dust collecting filter in applications of environmental measures such as pollution preventive measures, recovery of a product from a high-temperature gas and the like. The honeycomb structure is especially used as a dust collecting filter such as a diesel particulate filter (DPF) which traps particulates discharged from a diesel engine in an atmosphere of a corrosive gas at a high temperature.

What is claimed is:

1. A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure,
the method comprising: picking up an image of an end surface of the honeycomb structure beforehand;
then synthesizing a predetermined plugging pattern at an end-surface cell group of the honeycomb structure end surface by processing of the picked-up image;
printing the resulting synthetic image on a photo-setting or thermosetting resin film formed on the honeycomb structure end surface;
then irradiating the honeycomb structure end surface with light or heat;
leaving a portion which has set while removing the film to form an opening having the predetermined plugging pattern at the photo-setting or thermosetting resin film; and
filling the cells of the honeycomb structure with a plugging material to form the plugging portions.

2. The manufacturing method of the plugged honeycomb structure according to claim 1, wherein the synthesized plugging pattern is printed beforehand on the photo-setting or thermosetting resin film; and the film is attached to the end surface of the honeycomb structure.

3. A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure,
the method comprising:
filling all of the cells of a honeycomb structure end surface with a plugging material beforehand;
then forming a photo-setting or thermosetting resin film on the end surface;
picking up an image of the end surface of the honeycomb structure beforehand;
then synthesizing a predetermined plugging pattern at an end-surface cell group of the honeycomb structure end surface by processing of the picked-up image;
printing the resulting synthetic image on the photo-setting or thermosetting resin film formed on the honeycomb structure end surface;
then irradiating the honeycomb structure end surface with light or heat so that the photo-setting or thermosetting resin film of the predetermined cell sets;
removing the photo-setting or thermosetting resin film which has not set together with the plugging material;
then removing the photo-setting or thermosetting resin film which has set to form the plugging portions.

4. A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure,
the method comprising:
filling all of the cells of the honeycomb structure with a plugging material containing a photo-setting or thermosetting resin beforehand;
irradiating an end surface with laser in the form of a plugging pattern based on information of a honeycomb structure end surface image picked up beforehand so that the plugging material of the predetermined cell sets; and
removing the plugging material which has not set to thereby form the plugging portions.

5. A manufacturing method of a plugged honeycomb structure including porous partition walls which form a plurality of cells divided as channels of a fluid in the form of a honeycomb and a plugging portion formed at one opening end portion of a predetermined cell of a cylindrical honeycomb structure,
the method comprising:
filling all of the cells of a honeycomb structure end surface with a plugging material beforehand;
then forming a photo-setting or thermosetting resin film on the end surface of the honeycomb structure;
then irradiating the end surface with laser in the form of a plugging pattern based on information of a honeycomb structure end surface image picked up beforehand so that the photo-setting or thermosetting resin film of the predetermined cell sets;
removing the photo-setting or thermosetting resin film which has not set together with the plugging material; and
then removing the photo-setting or thermosetting resin film which has set to thereby form the plugging portions.
